(19) United States
(12) Patent Application Publication
(10) Pub. No.: US 2013/0003738 A1
(43) Pub. Date: Jan. 3, 2013

(54) TRILL BASED ROUTER REDUNDANCY

(75) Inventors: Phanidhar Koganti, Sunnyvale, CA (US); Suresh Vobbilisetty, San Jose, CA (US); Shunjia Yu, San Jose, CA (US); Anoop Ghanwani, Rocklin, CA (US); Syed Hasan Raza Naqvi, Kariyammana Agrahara Village (IN); Rajiv Krishnamurthy, San Jose, CA (US)

(73) Assignee: BROCADE COMMUNICATIONS SYSTEMS, INC., San Jose, CA (US)

(21) Appl. No.: 13/288,822

(22) Filed: Nov. 3, 2011

Related U.S. Application Data
(60) Provisional application No. 61/502,701, filed on Jun. 29, 2011.

(51) Int. Cl. H04L 12/28

(52) U.S. Cl. 370/392

(57) ABSTRACT

One embodiment of the present invention provides a switching system. The switching system includes a Transparent Interconnection of Lots of Links (TRILL) header processor and an Internet Protocol (IP) header processor. The TRILL header processor is configured to identify a virtual routing bridge (RBridge) identifier in a packet, and the IP header processor is configured to identify a virtual IP address in the packet. The virtual IP address is assigned to a virtual IP router associated with the virtual RBridge identifier.

### RELATED APPLICATIONS

This application claims the benefit of U.S. Provisional Application No. 61/502,701, Attorney Docket Number BRCD-3057.0.1.US.PSP, titled “Trill Based Router Redundancy,” by inventors Phanidhar Koganti, Suresh Vobbilisetty, Shunjia Yu, Anoop Ghanwani, Syed Hasan Raza Naqvi, and Rajiv Krishnamurthy, filed 29 Jun. 2011, which is incorporated by reference herein.

The present disclosure is related to U.S. patent application Ser. No. 13/087,239, (attorney docket number BRCD-3008.1.US.NP), titled “Virtual Cluster Switching,” by inventors Suresh Vobbilisetty and Dilip Chatwani, filed 14 Apr. 2011, and U.S. patent application Ser. No. 12/725,249, (attorney docket number BRCD-112-0439US), titled “Redundant Host Connection in a Routed Network,” by inventors Somesh Gupta, Anoop Ghawani, Phanidhar Koganti, and Shunjia Yu, filed 16 Mar. 2010, the disclosures of which are incorporated by reference herein.

### BACKGROUND

1. Field

The present disclosure relates to network management. More specifically, the present disclosure relates to a method and system for facilitating load balancing and redundancy for switching devices in a network.

2. Related Art

As more time-critical applications are being implemented in data communication networks, high-availability operation is becoming progressively more important as a value proposition for network architects. It is often desirable to aggregate multiple network devices to operate as a single logical device to facilitate load balancing among the multiple network devices while providing redundancy to ensure that a device failure or link failure would not affect the data flow.

Meanwhile, layer-2 (e.g., Ethernet) networking technologies continue to evolve. More routing-like functionalities, which have traditionally been the characteristics of layer-3 (e.g., Internet Protocol or IP) networks, are migrating into layer-2. Notably, the recent development of the Transparent Interconnection of Lots of Links (TRILL) protocol allows Ethernet switches to function more like routing devices. TRILL overcomes the inherent inefficiency of the conventional spanning tree protocol, which forces layer-2 switches to be coupled in a logical spanning-tree topology to avoid looping. TRILL allows routing bridges (RBridges) to be coupled in an arbitrary topology without the risk of looping by implementing routing functions in switches and including a hop count in the TRILL header.

While TRILL brings many desirable features to layer-2 networks, some issues remain unsolved with layer-3 devices. Particularly, when a number of TRILL devices also serve as layer-3 routers, existing technologies do not provide a scalable and flexible solution which takes full advantage of the TRILL network, especially with respect to load balancing and redundancy.

### SUMMARY

One embodiment of the present invention provides a switching system. The switching system includes a Transparent Interconnection of Lots of Links (TRILL) header processor and an Internet Protocol (IP) header processor. The TRILL header processor is configured to identify a virtual routing bridge (RBridge) identifier in a packet, and the IP header processor is configured to identify a virtual IP address in the packet. The virtual IP address is assigned to a virtual IP router associated with the virtual RBridge identifier.

In a variation on this embodiment, the virtual IP address is assigned to an interface of the virtual IP router.

In a variation on this embodiment, the virtual IP router in the switching system is formed based on a plurality of physical RBridges with IP processing capabilities.

In a variation on this embodiment, the virtual RBridge in the switching system is formed based on a plurality of physical RBridges.

In a variation on this embodiment, the switching system further includes an Ethernet header processor unit configured to identify a virtual Medium Access Control (MAC) address assigned to the virtual IP router.

In a variation on this embodiment, the switching system includes an Address Resolution Protocol (ARP) module configured to respond to an ARP request for the virtual IP address with the virtual MAC address.

In a variation on this embodiment, the virtual IP router in the switching system is a default gateway router.

In a variation on this embodiment, the switching system includes a priority configuration mechanism which allows a priority to be set, thereby facilitating election of one of a plurality of physical RBridges that form the virtual IP router.

### BRIEF DESCRIPTION OF THE FIGURES

FIG. 1 illustrates an exemplary network where a virtual RBridge and an associated virtual IP router are created based on a plurality of physical gateway RBridges with IP processing capabilities, in accordance with an embodiment of the present invention.

FIG. 2 illustrates an exemplary configuration of how a virtual RBridge and a virtual IP router can be logically coupled with different RBridges in a TRILL network and how layer-2 and layer-3 network devices are coupled with the TRILL network, in accordance with an embodiment of the present invention.

FIG. 3A presents a flowchart illustrating the process of an end device using a virtual IP router as a default gateway router, in accordance with an embodiment of the present invention.

FIG. 3B presents a flowchart illustrating the process of a gateway RBridge associated with a virtual RBridge responding to an ARP request for a virtual IP address, in accordance with an embodiment of the present invention.

FIG. 4 illustrates an exemplary network where a number of gateway RBridges associated with a virtual RBridge are directly coupled to an end device, in accordance with an embodiment of the present invention.

FIG. 5A illustrates an exemplary header configuration of an egress TRILL frame which contains a virtual RBridge nickname in its egress RBridge nickname field and a virtual MAC address in its destination MAC address field, in accordance with an embodiment of the present invention.

FIG. 5B illustrates an exemplary header configuration of an egress TRILL frame which contains a virtual RBridge nickname in its TRILL option field and a virtual MAC address in its destination MAC address field, in accordance with an embodiment of the present invention.

FIG. 6 presents a flowchart illustrating the process of a gateway RBridge associated with the virtual RBridge forwarding a TRILL packet, in accordance with an embodiment of the present invention.

FIG. 7 illustrates a scenario where one of the RBridges associated with the virtual RBridge experiences a link failure and/or a node failure, in accordance with an embodiment of the present invention.

FIG. 8 illustrates an exemplary architecture of a switch which facilitates creation of a virtual RBridge and a virtual IP router, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of providing scalable and flexible redundancy and load balancing features to gateway routers is solved by forming a logical, virtual router based on multiple physical switches in a TRILL network. For example, a number of TRILL RBridges with IP processing capabilities may act as layer-3 routers for an end device. These RBridges form a virtual RBridge, which is assigned with a virtual RBridge identifier (ID). Furthermore, these RBridges form a virtual IP router, which has a virtual IP address assigned to at least one interface and a corresponding virtual MAC address. This virtual IP router operates as a default gateway router and the virtual IP address serves as a default gateway router address for the end devices.

During operation, an end device obtains the virtual MAC address by sending an ARP request with the virtual IP address. An outgoing layer-2 frame from the end device sets the virtual MAC address as the destination MAC address. When the frame is inserted into the TRILL network, a virtual RBridge nickname corresponding to the virtual RBridge ID is assigned as its egress RBridge nickname and the frame is forwarded through the rest of the TRILL network. Other end devices which are coupled to the same TRILL network in a similar way can use the same virtual RBridge nickname as their egress RBridge nickname. To the rest of the TRILL network, the frame appears to be destined to the virtual RBridge and is routed to one of the RBridges which form the virtual gateway router. The use of such a virtual RBridge allows load balancing while proving redundancy among RBridges corresponding to the virtual gateway router. When one of the these RBridges suffers a link and/or a node failure, the affected link and/or node is removed from the paths to the virtual RBridge in the TRILL network and alternative paths can be used to forward TRILL packets. This configuration allows fast protection switching and load balancing among the physical IP-capable RBridges that form the virtual gateway router.

Although the present disclosure is presented using examples based on the TRILL protocol, embodiments of the present invention are not limited to TRILL networks, or networks defined in a particular Open System Interconnection Reference Model (OSI reference model) layer.

The term “RBridge” refers to routing bridges, which are bridges implementing the TRILL protocol as described in IETF Request for Comments (RFC) “Routing Bridges (RBridges): Base Protocol Specification,” available at http://tools.ietf.org/html/rfc6325, which is incorporated by reference herein. Embodiments of the present invention are not limited to the application among RBridges. Other types of switches, routers, and forwarders can also be used.

In this disclosure, the term “edge port” refers to a port which sends/receives data frames in native Ethernet format. The term “TRILL port” refers to a port which sends/receives data frames encapsulated with a TRILL header and outer MAC header.

The term “end device” refers to a network device that is typically not TRILL-capable. “End device” is a relative term with respect to the TRILL network. However, “end device” does not necessarily mean that the network device is an end host. An end device can be a host, a conventional layer-2 switch, or any other type of network device. Additionally, an end device can be coupled to other switches or hosts further away from the TRILL network. In other words, an end device can be an aggregation point for a number of network devices to enter the TRILL network.

The term “IP-capable RBridge” refers to a physical RBridge that can route IP packets. An IP-capable RBridge can be coupled to a layer-3 network and can forward IP packets from end devices to the layer-3 network. A number of IP-capable RBridges form the virtual RBridge and the corresponding virtual IP router, thereby facilitating a virtual gateway router for end devices that supports redundancy and load-balancing. In this disclosure, an RBridge which forms the virtual RBridge and the virtual IP router is also referred to as a “gateway” RBridge. A gateway RBridge responds to ARP requests for the virtual IP address with a virtual MAC address. In various embodiments, any arbitrary number of gateway RBridges can form the virtual RBridge. As gateway RBridges can process both TRILL and IP packets, in this disclosure the term “gateway RBridge” can refer to both a physical RBridge in a TRILL network and a physical router in an IP network.

The term “IP router” refers to both the IP capable portion of an RBridge and a stand-alone IP router. In this disclosure, the terms “IP router” and “router” are used interchangeably.

The term “frame” refers to a group of bits that can be transported together across a network. “Frame” should not be interpreted as limiting embodiments of the present invention to layer-2 networks. “Frame” can be replaced by other terminologies referring to a group of bits, such as “packet,” “cell,” or “datagram.”

The term “RBridge identifier” refers to a group of bits that can be used to identify an RBridge. Note that the TRILL standard uses “RBridge ID” to denote a 48-bit intermediate-system-to-intermediate-system (IS-IS) System ID assigned to an RBridge, and “RBridge nickname” to denote a 16-bit value that serves as an abbreviation for the “RBridge ID.” In this disclosure, “RBridge identifier” is used as a generic term and is not limited to any bit format, and can refer to “RBridge ID” or “RBridge nickname” or any other format that can identify an RBridge.

The term “MAC address” refers to a 48-bit value that can be used to identify a networking device in layer-2. Any device implementing layer-2 or above is assigned with a MAC address. A MAC address associated with a networking device is permanent and does not change if the device changes location and point of attachment in the network.

The term “IP address” refers to a group of bits that can be used to identify a networking device in layer-3. For IP version 4, a 32-bit value is used for an IP address and for IP version 6, a 128-bit value is used for an IP address. Any device that implements layer-3 or above requires an IP address to send or receive data in an IP network. In this disclosure, “IP address” is used as a generic term and is not limited to any IP version.

The term “Address Resolution Protocol” or “ARP” refers to a protocol for discovering a network interface's MAC address when only a corresponding IP address is known. “ARP” should not be interpreted as limiting embodiments of the present invention to IP version 4. “ARP” can be replaced by other terminologies referring to a protocol, such as “Neighbor Discovery Protocol” used for identifying the hardware address of a network interface.

### Network Architecture

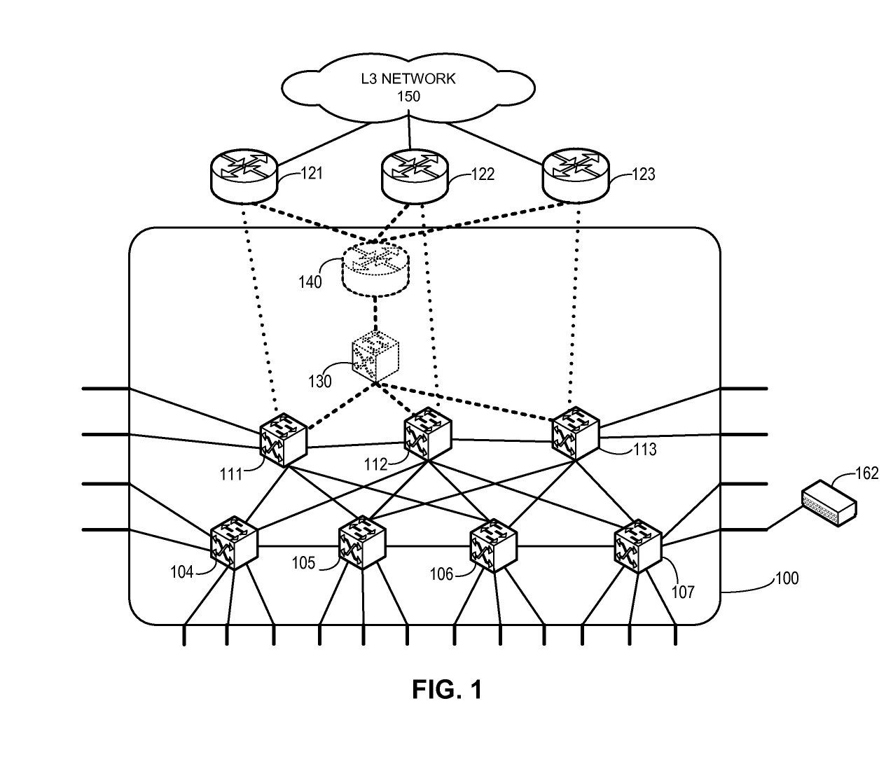

FIG. 1 illustrates an exemplary network where a virtual RBridge and an associated virtual IP router are created based on a plurality of physical RBridges with IP processing capabilities, in accordance with an embodiment of the present invention. As illustrated in FIG. 1, a TRILL network 100 includes RBridges, 104, 105, 106, 107, 111, 112, and 113. RBridges 111, 112, and 113 operate as gateway RBridges and are coupled to a layer-3 network 150 as IP routers, 121, 122, and 123, respectively. For example, gateway RBridge 111 and IP router 121 are same physical device (represented by dotted lines), where its TRILL RBridge portion is denoted by gateway RBridges 111 and its IP router portion is denoted by router 121. Similarly, gateway RBridge 112 and IP router 122; and gateway RBridge 113 and IP router 123 are the same physical devices, respectively.

Gateway RBridges 111, 112, and 113 form a virtual RBridge 130 by operating as a single logical RBridge in TRILL network 100. Similarly, the corresponding IP routers 121, 122, and 123 form a virtual IP router 140 by operating as a single logical IP router. An end device 162 coupled to network 100 through RBridge 107 can use virtual IP router 140 as the default gateway router to layer-3 network 150.

During operation that does not involve router redundancy, an end device may select only one IP router as the gateway to the layer-3 network and use the corresponding IP address of the IP router as a default gateway address. For example, in FIG. 1, router 121 may be configured as the default gateway router for end device 162 and a corresponding IP address is assigned as a default gateway IP address. When the end device 162 injects a frame destined to IP network 150 into TRILL network 100, the frame is received by the ingress RBridge 107. The frame is then encapsulated in a TRILL packet at RBridge 107 and is routed through network 100 toward egress RBridge 111. Upon receiving the frame, the IP router 121 at the egress RBridge extracts the IP packet from the frame and forwards the IP packet to network 150. If gateway router 121 fails, another gateway router (e.g., router 123) would need to be configured as the default gateway for end device 162. Based on the conventional virtual router redundancy protocol (VRRP), the backup router 123 forwards traffic from end device 162 only if router 121 fails. Consequently, the backup process becomes an “active-standby” model when, for an end device, only one gateway router remains active while others remain on standby. Note that there may be multiple standby routers, but only one may act as the default gateway for an end device at any point of time. Such a configuration is inefficient and not very scalable.

In embodiments of the present invention, as illustrated in FIG. 1, Virtual RBridge 130 is considered to be logically coupled to gateway RBridges 111, 112, and 113, optionally with zero-cost links represented by dashed lines. Furthermore, RBridges 111, 112, and 113 can advertise their respective connectivity (optionally via zero-cost links) to virtual RBridge 130. As a result, other RBridges in the TRILL network can learn that virtual RBridge 130 is reachable via RBridges 111, 112, and 113, and establish TRILL paths to virtual RBridge 130 using a corresponding virtual RBridge ID through these RBridges.

All the IP-layer router portions of these RBridges are configured to operate as the layer-3 gateway router (i.e., virtual IP router 140) for end device 162. End device 162 uses virtual IP router 140 as the default gateway. As virtual RBridge 130 is associated with virtual IP router 140, incoming frames from end device 162 destined to network 150 are marked with virtual RBridge 130's nickname as the egress RBridge nickname. Consequently, all frames from end device 162 to network 150 are delivered to one of the gateway RBridges 111, 112, and 113. Hence, load balancing can be achieved among gateway RBridges 111, 112, and 113 for frames sent to virtual RBridge 130.

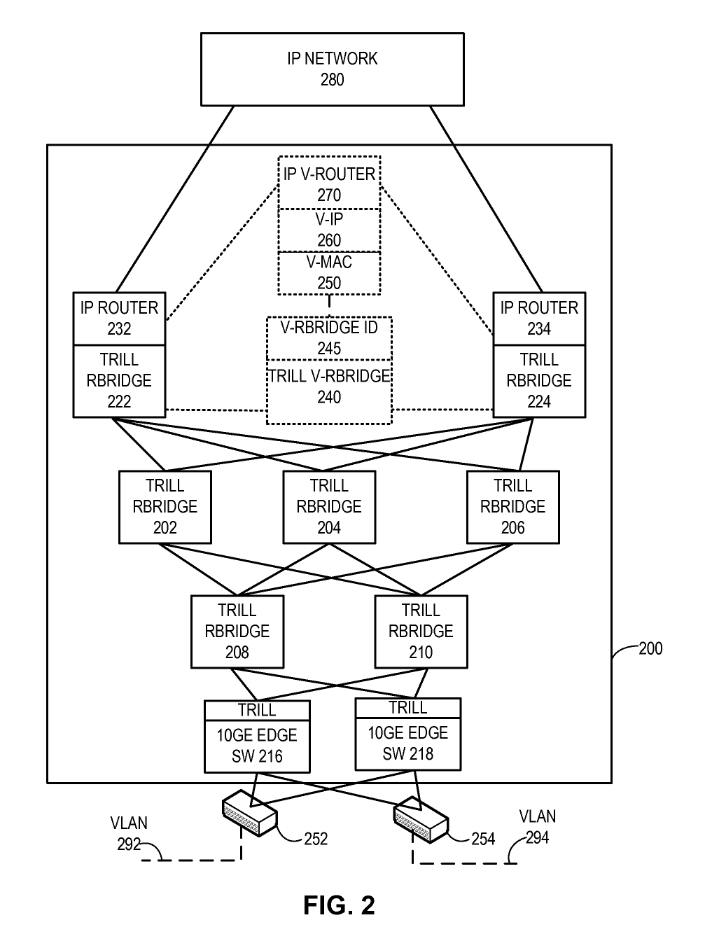

FIG. 2 illustrates an exemplary configuration of how a virtual RBridge and a virtual IP router can be logically coupled to different RBridges in a TRILL network and how layer-2 and layer-3 network devices are coupled to the TRILL network, in accordance with an embodiment of the present invention. In this example, a TRILL network 200 includes a number of TRILL RBridges 202, 204, 206, 208, and 210. Network 200 also includes RBridges 216 and 218, each with a number of edge ports which can be coupled to external networks. For example, RBridges 216 and 218 are coupled with end devices 252 and 254 via 10GE edge ports. RBridges in network 200 are in communication with each other using the TRILL protocol.

Also included in network 200 are RBridges 222 and 224, which are layer-3 capable and coupled to an IP network 280 as IP routers 232 and 234. Gateway RBridges 222 and 224 form virtual RBridge 240 with virtual RBridge ID 245. Physically co-located IP Routers 232 and 234 within gateway RBridges 222 and 224, respectively, form a virtual IP router 270 which is assigned a virtual IP address 260 (on at least one interface) and a virtual MAC address 250. Virtual IP address 260 maps to virtual MAC address 250 for ARP requests directed to virtual IP router 270. Furthermore, virtual RBridge ID 245 is associated with virtual MAC address 250. End devices 252 and 254 can set virtual IP address 260 as their default gateway router address and use ARP to obtain virtual MAC address 250. End devices 252 and 254 send frames with virtual MAC address 250 as the destination MAC address into network 200. The frames are encapsulated in TRILL packets and routed toward virtual RBridge 240 using a virtual RBridge nickname associated with the corresponding virtual RBridge ID 245.

In some embodiments, a different virtual IP address can be assigned to each interface associated with different virtual Local Area Networks (VLANs) in a TRILL network. For example, in FIG. 2, end device 252 may belong to VLAN 292 and end device 254 may belong to VLAN 294. End devices 252 and 254 then set different virtual IP addresses associated with VLAN 292 and VLAN 294, respectively, as their respective default gateway router addresses. Consequently, end devices 252 and 254 perceive virtual IP router 270 to be in VLAN 292 and VLAN 294, respectively. For ARP requests for either virtual IP address, the same virtual MAC address 250 is sent in the ARP reply (it is possible to use different addresses for each VLAN if so desired). All data frames injected to TRILL network 200 with virtual MAC address 250 as the destination MAC address are routed toward virtual RBridge 240. Note that, in one embodiment, the virtual MAC address is known to all RBridges in network 200. Otherwise, both IP routers 232 and 234 could receive a frame forwarded to virtual MAC address 250 and results in packet duplication. Hence, after formation of virtual RBridge 240 and virtual IP router 270, all RBridges in network 200 are provided with the knowledge about virtual MAC address 250. That is, virtual MAC address 250 is always “known” to all ingress RBridges in network 200, and frames destined to virtual MAC address 250 are routed through network 200 using TRILL unicast. Alternatively, in a further embodiment where knowledge of the virtual MAC address is not always “known” to all ingress RBridges, one of the gateway RBridges can be elected to be the forwarder for frames received as a TRILL multicast frame (which would be the case when the virtual MAC address is not known to an ingress RBridge).

In some embodiments, only one gateway RBridge is elected to reply to ARP requests for the virtual IP address. This election can also be VLAN-specific. Note that TRILL is only used as a transport between the switches within network 200. This is because TRILL can readily accommodate native Ethernet frames. Also, the TRILL standards provide a ready-to-use forwarding mechanism that can be used in any routed network with arbitrary topology. Embodiments of the present invention should not be limited to using only TRILL as the transport. Other protocols that support routing (such as multi-protocol label switching (MPLS)), either public or proprietary, can also be used for the transport.

### ARP Processing

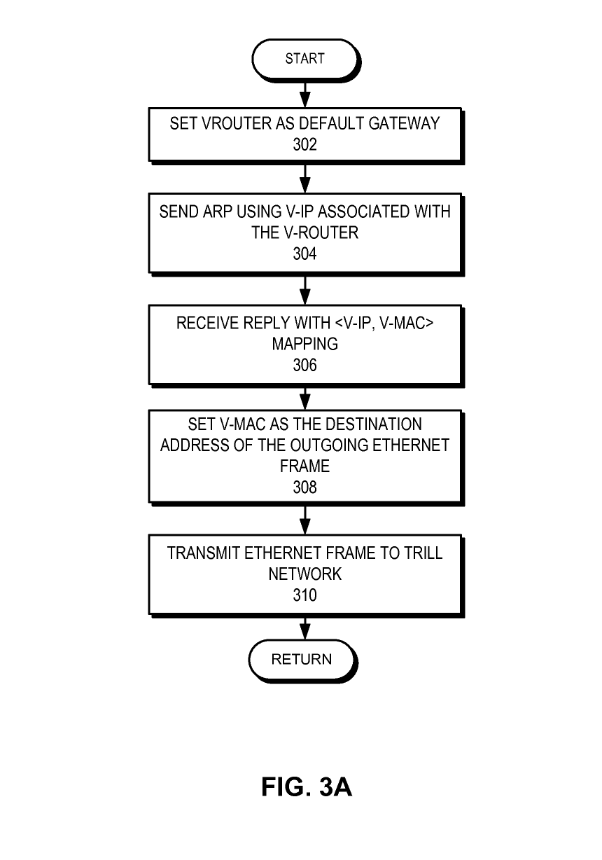

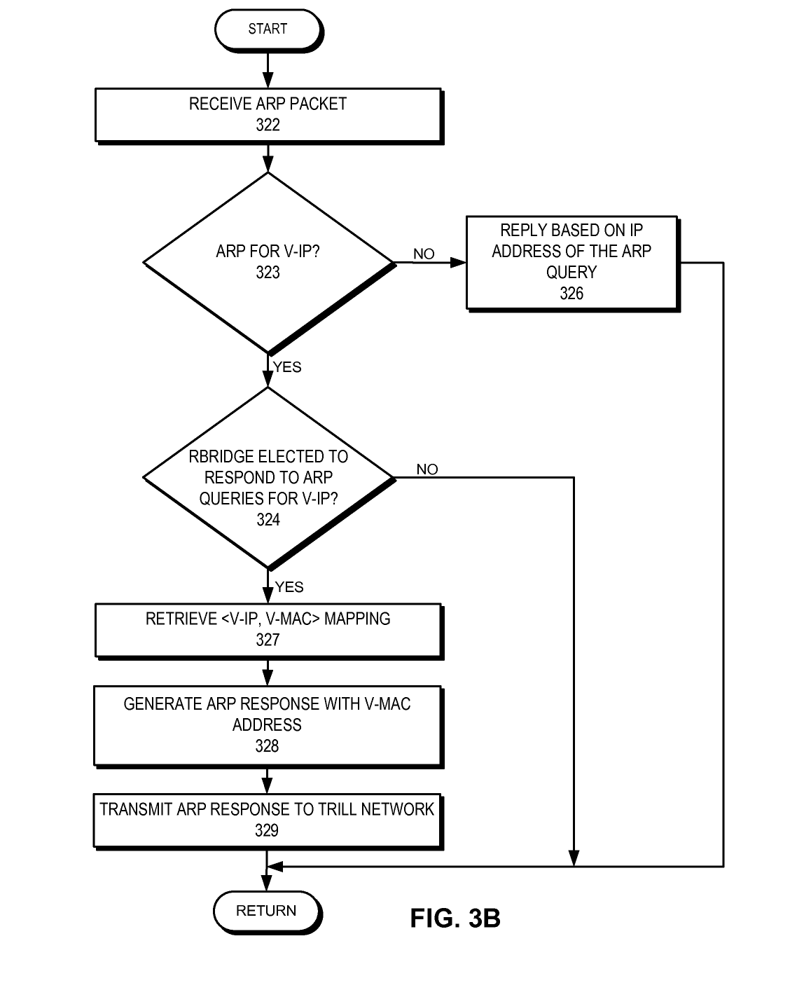

FIG. 3A presents a flowchart illustrating the process of an end device using a virtual IP router as the default gateway router, in accordance with an embodiment of the present invention. When an end device turns on, it obtains the virtual IP address as the default gateway address (operation 302).

During operation, when the end device has frames to transmit to an IP network, it prepares an ARP request using the virtual IP address and sends the query to a TRILL network it is coupled to (operation 304). The end device receives the ARP reply from the TRILL network with the virtual MAC address corresponding to the virtual IP address (operation 306). Note that the end device does not need to recognize the MAC address as “virtual” and considers the address to be a regular MAC address. The end device encapsulates an IP packet destined to the IP network in an Ethernet frame and sets the destination MAC address to be the virtual MAC address obtained from the ARP request (operation 308). The end device then transmits the frame to the TRILL network (operation 310).

FIG. 3B presents a flowchart illustrating the process of a gateway RBridge associated with a virtual RBridge responding to an ARP request for a virtual IP address, in accordance with an embodiment of the present invention. Upon receiving an ARP request packet for an IP address (operation 322), the gateway RBridge checks whether the ARP request is for a virtual IP address (operation 323). If not, the gateway RBridge responds based on the IP address in the ARP request (assuming that IP address is the gateway RBridge's physical IP address) (operation 326). Otherwise, the gateway RBridge checks whether it is elected to respond to an ARP request for the virtual IP address (operation 324). If not, the ARP request is discarded. Otherwise the gateway RBridge retrieves the virtual MAC address for the virtual IP address (operation 327) and generates an ARP reply containing the virtual MAC address (operation 328). The gateway RBridge transmits the ARP reply to the TRILL network (operation 329). Note that an ARP request is disseminated in the TRILL network using multicast and each IP-capable RBridge, including the one elected to respond to ARP requests for the virtual IP address, receives the query. However, the ARP reply is sent as a unicast transmission in the TRILL network to the end device.

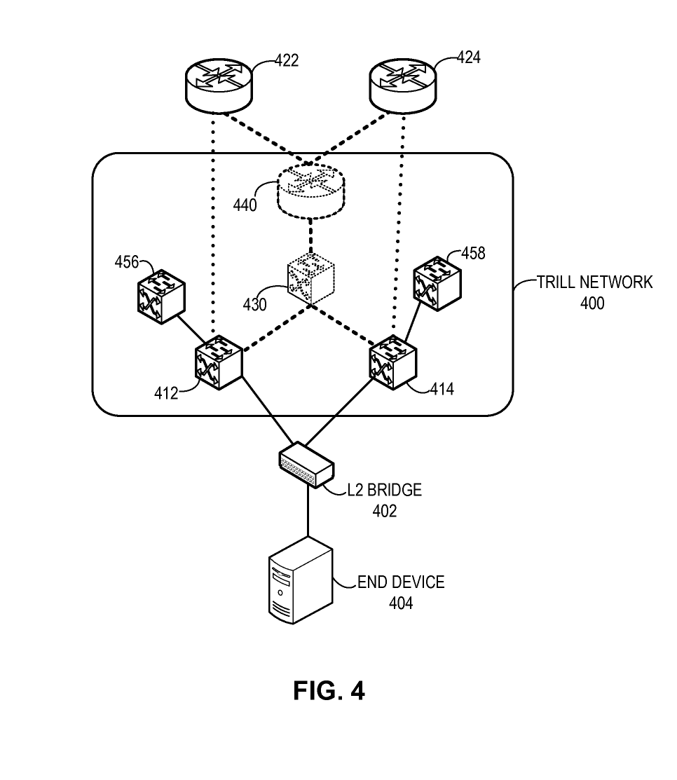

In some embodiments, a gateway RBridge may not have any other intermediate RBridge between itself and an end device. FIG. 4 illustrates an exemplary network where a number of gateway RBridges associated with a virtual RBridge are directly coupled to an end device, in accordance with an embodiment of the present invention. In this example, TRILL network 400 includes a virtual RBridge 430 formed by RBridges 412 and 414. IP router portions of RBridges 412 and 414, which are denoted as IP router 422 and 424, form virtual IP router 440. Network 400 also includes RBridges 456 and 458. Layer-2 bridge 402 is coupled to network 400 through gateway RBridges 412 and 414. End device 404 is coupled to layer-2 bridge 402.

In some embodiments, virtual IP router 440 and end device 404 may be in the same VLAN. When end device 404 sends an ARP request for a virtual IP address, an elected gateway RBridge among gateway RBridges 412 and 414 responds to the query.

### Frame Processing

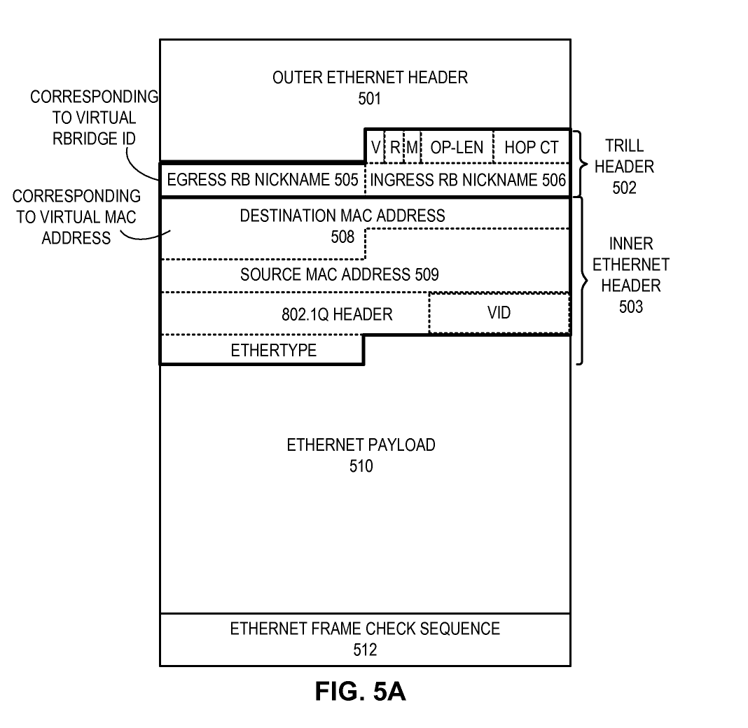

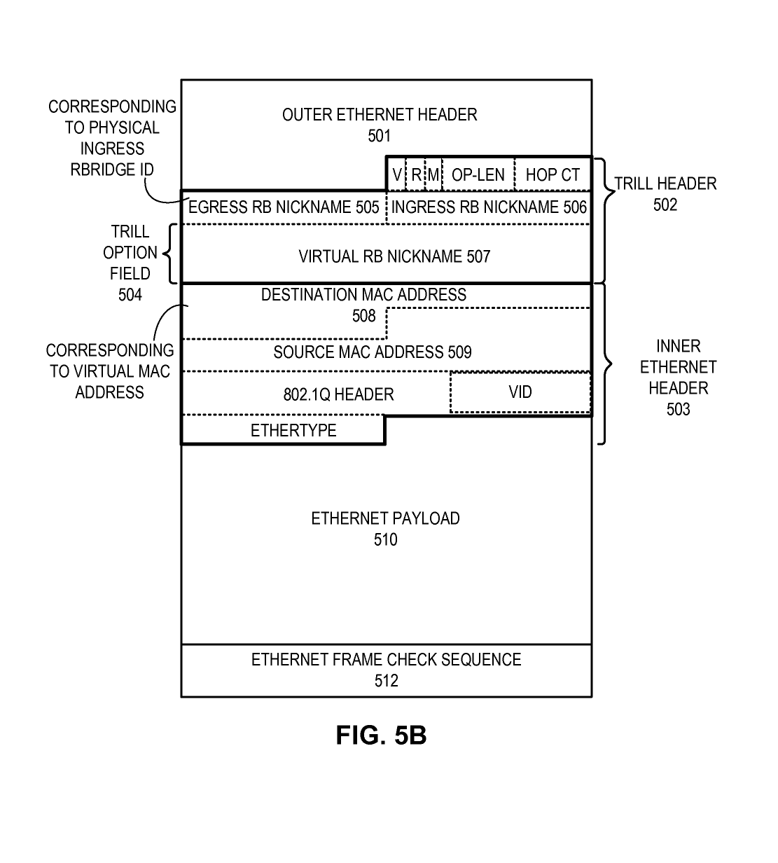

FIG. 5A illustrates an exemplary header configuration of an egress TRILL frame which contains a virtual RBridge nickname in its egress RBridge nickname field and a virtual MAC address in its inner destination MAC address field, in accordance with an embodiment of the present invention. In this example, a TRILL-encapsulated frame includes an outer Ethernet header 501, a TRILL header 502, an inner Ethernet header 503, an Ethernet payload 510, and an Ethernet frame check sequence (FCS) 512.

TRILL header 502 includes a version field (denoted as “V”), a reserved field (denoted as “R”), a multi-destination indication field (denoted as “M”), an option-field-length indication field (denoted as “OP-LEN”), and a hop-count field (denoted as “HOP CT”). Also included are an egress RBridge nickname field 505 and an ingress RBridge nickname field 506.

Inner Ethernet header 503 includes a destination MAC address field 508 and a source MAC address field 509. Header 503 can also include a 802.1Q header, which includes a virtual LAN identifier (VID). For all frames destined to the virtual IP router, the destination MAC address field 508 corresponds to the virtual MAC address assigned to the virtual IP router.

In some embodiments, in addition to carrying the virtual RBridge's nickname in the egress RBridge nickname field, it is possible to include the physical egress RBridge nickname in the TRILL option field. This configuration can facilitate end-to-end congestion notification and help with multicast suppression scenarios.

Furthermore, it is also possible to carry the virtual RBridge identifier in the TRILL option field, instead of the destination RBridge nickname field. The egress RBridge nickname field of an outgoing frame is used to carry the nickname of the physical egress RBridge. This configuration allows other RBridges in the TRILL network to identify the actual, physical egress RBridge as well as the virtual egress RBridge.

FIG. 5B illustrates an exemplary header configuration of a TRILL frame which contains a virtual egress RBridge nickname in its TRILL option field, in accordance with an embodiment of the present invention. For all frames destined to the virtual IP router, the destination MAC address field 508 corresponds to a virtual MAC address. In this example, the frame's option-field-length field “OP-LEN” indicates the length of its TRILL option field 504. TRILL option field 504 includes the virtual RBridge nickname 507 (the option type is used to indicate that this is a virtual egress RBridge nickname). The egress RBridge nickname field 505 carries the nickname of the physical egress RBridge. To properly identify the RBridge nickname, the ingress RBridge in the TRILL network is assumed to be capable of encoding the TRILL option field 504, and the egress RBridge that it is destined to is likewise assumed to be capable of decoding this field. Note that the top two bits of the first octet of the options area are a Critical Hop by Hop (CHbH) bit and a Critical Ingress to Egress (CItE) bit. The CHbH bit can be set to zero, and the CItE bit can be set to one. This way, only the ingress and egress RBridges are required to parse the option field, while a transit RBridge can ignore the existence of this option and perform its forwarding as it normally would as if the frame does not have the option field present.

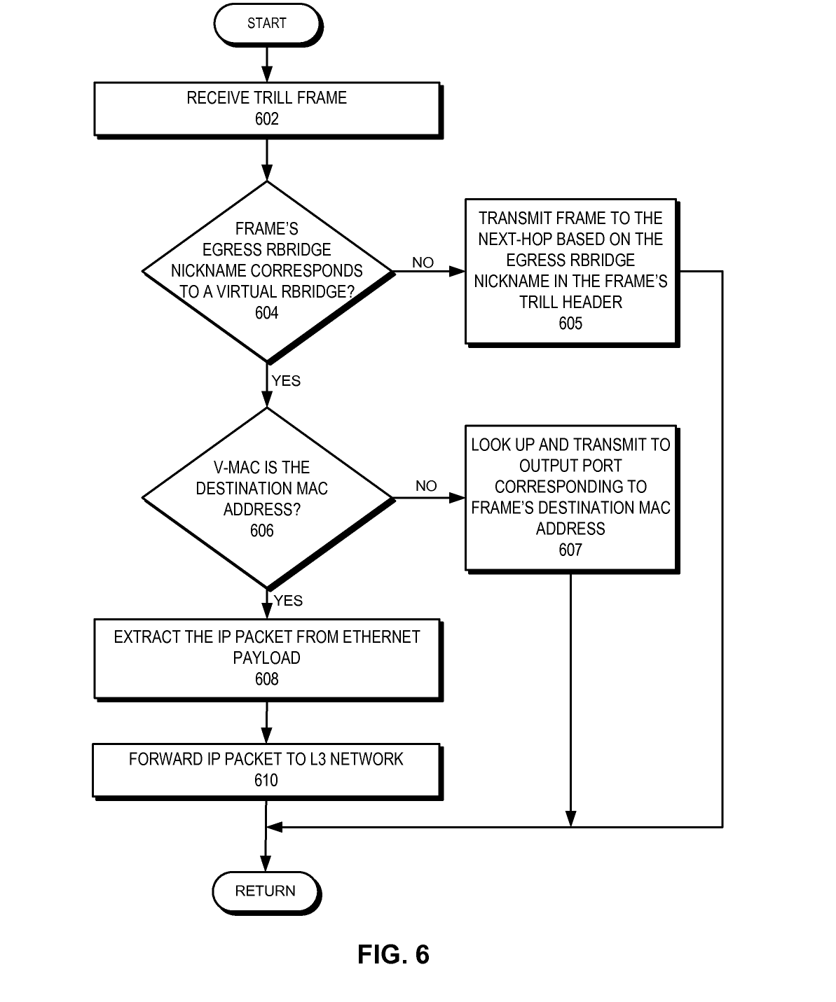

FIG. 6 presents a flowchart illustrating the process of a gateway RBridge associated with a virtual RBridge forwarding a TRILL frame, in accordance with an embodiment of the present invention. Upon receiving a TRILL frame (operation 602), the gateway RBridge checks whether the egress RBridge nickname in the TRILL header of the frame corresponds to a virtual RBridge or a local RBridge (operation 604). If the nickname does not corresponds to the virtual RBridge, the TRILL frame is forwarded to the next-hop RBridge based on the egress RBridge nickname (operation 605). Otherwise, the gateway RBridge checks whether the destination MAC address of the Ethernet frame encapsulated in the TRILL frame is the associated virtual MAC address (operation 606). If so, then the frame is destined to an IP network the gateway RBridge is coupled to. Hence, the IP packet is extracted from the Ethernet payload of the frame (operation 608). The gateway RBridge checks the IP address of the IP packet and performs layer-3 IP forwarding toward the IP network (operation 610). On the other hand, if the destination MAC address is not the virtual MAC address, then the virtual RBridge is for multi-homed layer-2 end devices. Accordingly, the gateway RBridge looks up and transmits to the output port corresponding to the destination MAC address (operation 607). Operations of virtual RBridges for multi-homed end devices is specified in the U.S. Patent Publication No. 2010/0246388, titled “Redundant Host Connection in a Routed Network,” the disclosure of which is incorporated herein in its entirety. For example, if a frame is forwarded by a RBridge that has not yet learned about the virtual MAC address, this RBridge would normally forward the frame as a TRILL multicast frame. In this case, one of the gateway RBridges can be elected to process this TRILL multicast frame, while the other gateway RBridges simply discard it even though they will also receive a copy of the same frame.

### Pine/Telnet to Virtual IP Address

In some embodiments, an administrator or a user may try to ping to a default gateway router to check its accessibility. Since a virtual IP router is assigned as the default gateway, the capability to accept data packets destined to virtual IP addresses is desirable. Traffic to a virtual IP router may take a route to any of the gateway RBridges. Hence, in one embodiment, all gateway RBridges associated with the virtual IP router can respond to the ping requests.

On the other hand, for a stateful protocol such as telnet, one gateway RBridge can be elected to respond and maintain a stateful session. Otherwise, if two telnet sessions are created to the virtual IP address, they can be routed to different gateway RBridges and the states that each sees are different.

While responding to ping/telnet packets, the source MAC address in outgoing Ethernet frames should be replaced with the virtual MAC address. This allows the intermediate RBridges to refresh the virtual MAC address forwarding entry, as shown in FIG. 4. In addition, a gateway RBridge can send out gratuitous ARP replies toward all other RBridges in the TRILL network to refresh their virtual MAC address forwarding entry, which prevents the entry from aging out.

For example, referring back to FIG. 2, when a ping request comes from end device 252 for virtual IP router 270, intermediate RBridge 216 sends the ping frame to only one of the gateway RBridges, such as gateway RBridge 222. However, if the virtual MAC address is not “known,” the ping frame could be sent to both gateway RBridges, and only the elected gateway RBridge will respond. When another ping request comes from end device 252 for virtual IP router 270, intermediate RBridge 216 may send the ping frame to another gateway RBridge 224. Hence, both gateway RBridge 222 and 224 should be able to respond to ping.

On the other hand, when a telnet request comes from end device 252 for virtual IP router 270, one of the gateway RBridges, such as RBridge 222, is elected to respond to it. Ingress RBridges 216 and 218 can be configured to always send the telnet frames from the same telnet session to RBridge 222.

In another example, referring back to FIG. 4, if bridge 402 is coupled to TRILL network 400 using virtual link aggregation, gateway RBridges 412 and 414 may be coupled to bridge 402 via layer-3 ports. Under such a scenario, bridge 402 views itself as directly coupled to virtual RBridge 430 via a single (virtually aggregated) link. Forwarding policies over virtual aggregated link is specified in the U.S. Patent Publication No. 2010/0246388, titled “Redundant Host Connection in a Routed Network,” the disclosure of which is incorporated herein in its entirety.

### Failure Handling Using Redundancy

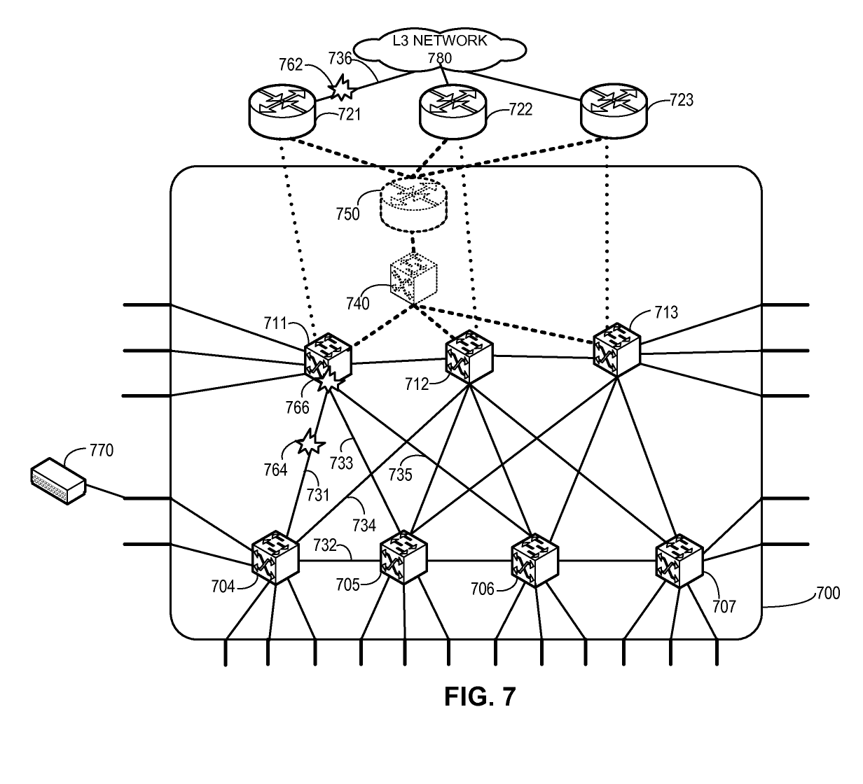

FIG. 7 illustrates a scenario where one of the RBridges associated with the virtual RBridge experiences a link failure and/or a node failure, in accordance with an embodiment of the present invention. In this example, in a TRILL network 700, RBridges 711, 712, and 713 form a virtual RBridge 740 and their respective IP-router portions denoted as IP routers 721, 722, and 723, form a virtual IP router 750. Note that in one embodiment IP routers 721, 722, and 723 form a virtual router only for the TRILL network and below. Above, where they communicate with other peer IP routers, they appear as three separate IP routers. Also included in network 700 are four RBridges 704, 705, 706, and 707. An end device 770 is connected to network 700 using RBridge 704 as the ingress RBridge. Virtual IP router 750 is set as a default gateway router for end device 770. Hence, all frames destined to network 780 from end device 770 have the virtual MAC address assigned to virtual IP router 750 as the destination MAC address. Note that these frames can be forwarded by gateway RBridges 711, 712, and 713 for load balancing. Gateway RBridges 711, 712, and 713 also provide redundancy among each other to handle failures.

Suppose that a failure 764 occurs to link 731 adjacent to gateway RBridge 711. As a result, link 731 is removed from routing decisions in network 700. All frames from end device 770 are still using the virtual MAC address as the destination address, and thus are still forwarded to any of the gateway RBridges via alternative links (e.g., links 732, 733, and 734).

Suppose that a failure 762 occurs during operation that fails link 736 adjacent to gateway RBridge 721. Consequently, IP router 721 is disconnected from network 780 and is incapable of forwarding frames to network 780. Under such a scenario, IP router 721 is removed from virtual IP router 750. As a result, IP router 721 stops operating as a layer-3 gateway router for end device 770. However, gateway RBridge 711 still remains connected to network 700 and continues to operate as a regular TRILL RBridge. As virtual IP router 750 still operates as a default gateway for end device 770, IP routers 722 and 723 can continue to operate as layer-3 gateway routers (as virtual IP router 750) for end device 770. Hence, all frames from end device 770 to network 780 are then distributed among gateway RBridges 712 and 713.

In some embodiments, with failure 762, an elected gateway RBridge stops responding to ARP requests for the virtual IP address and notifies other gateway RBridges. Consequently, the other gateway RBridges then elect among themselves another gateway RBridge to respond to ARP requests.

In some embodiments, with failure 762, IP router 721 might not immediately remove its membership from virtual IP router 750 and might continue to receive layer-3 traffic from end devices. Under such circumstances, gateway RBridge 711, the TRILL counterpart of IP router 721, forwards the layer-3 traffic with TRILL encapsulation to other gateway RBridges (e.g., gateway RBridge 712) which, in turn, forwards the traffic to network 780. However, if all similar IP routers suffer link failures and lose their connection to network 780, IP router 721 along with the other gateway RBridges with link failures are removed from virtual IP router 750. However, all gateway RBridges continue operating as TRILL RBridges.

Suppose that a node failure 766 occurs at gateway RBridge 711 (and essentially IP router 721 as they are the same physical device). As a result, links 731, 733, 735, and 736 fail as well. Consequently, gateway RBridge 711 and IP router 721 are disconnected from both network 700 and network 780, and are incapable of transmitting to or receiving from either network. Under such a scenario, IP router 721 is removed from virtual IP router 750 and gateway RBridge 711 is removed from virtual RBridge 740. As a result, IP router 721 stops operating as a layer-3 gateway node. Furthermore, gateway RBridge 711 is disconnected from network 700 and removed from all TRILL routes in network 700.

With failure 766, as virtual IP router 750 still operates as a default gateway for end device 770, routers 722 and 723 continue operating as layer-3 gateway nodes for end device 770. Hence, all frames from end device 770 to network 780 are distributed between gateway RBridges 712 and 713. Furthermore, if IP router 721 had been an elected router, it stops responding to ARP requests for the virtual IP address. Other RBridges coupled to the failed gateway RBridge can detect the failure and notify all RBridges, including other active gateway RBridges. Consequently, the active gateway RBridges can elect another gateway RBridge to respond to ARP requests.

### Exemplary Switch System

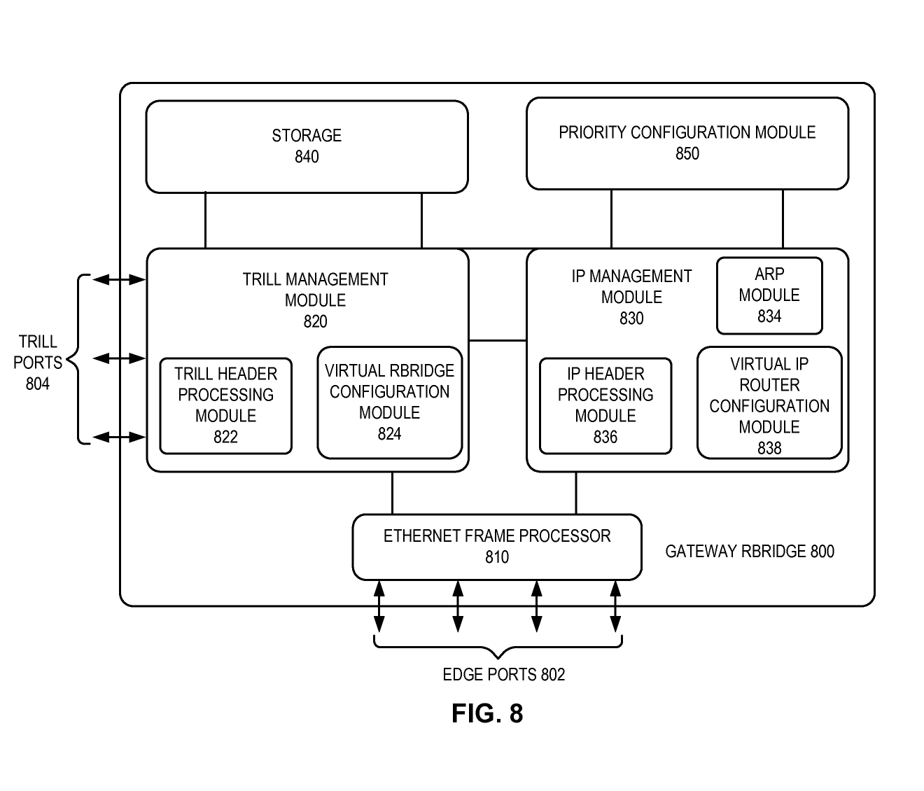

FIG. 8 illustrates an exemplary architecture of a switch which facilitates creation of a virtual RBridge and a virtual IP router, in accordance with an embodiment of the present invention. In this example, a gateway RBridge 800 includes a number of TRILL ports 804, an Ethernet frame processor 810, a TRILL management module 820, an IP management module 830, a storage 840, and a priority configuration module 850. TRILL management module 820 further includes a TRILL header processing module 822 and a virtual RBridge configuration module 824. IP management module 830 further includes an ARP module 834, IP header processing module 836, and a virtual IP router configuration module 838.

TRILL ports 804 include inter-switch communication channels for communication with one or more RBridges. This inter-switch communication channel can be implemented via a regular communication port and based on any open or proprietary format. Furthermore, the inter-switch communication between RBridges is not required to be direct port-to-port communication.

During operation, TRILL ports 804 receive TRILL frames from (and transmit frames to) other RBridges. TRILL header processing module 822 processes TRILL header information of the received frames and performs forwarding on the received frames based on their TRILL headers, as described in conjunction with FIG. 2. Furthermore, TRILL header processing module 822 generates the TRILL header and outer Ethernet header for ingress frames corresponding to the virtual RBridge. Virtual RBridge configuration module 824 manages the communication with gateway RBridges and handles various inter-switch communications, such as link and node failure notifications. Virtual RBridge configuration module 824 allows a user to configure and assign the identifier for the virtual RBridges and decides whether a frame has to be promoted to layer-3, as described in conjunction with FIG. 6.

TRILL management module 820 forwards frames destined to a virtual IP router toward the IP management module 830. IP management module 830 extracts the IP packet from the Ethernet payload, and IP header processing module 836 processes header information of the received IP packet and performs layer-3 forwarding based on its IP header, as described in conjunction with FIG. 6. Virtual IP router configuration module 838 handles various inter-switch communications, such as layer-3 link failure notification. Virtual IP router configuration module 838 allows a user to configure and assign virtual IP addresses and virtual MAC addresses.

Priority configuration module 850 allows a priority to be set for RBridge 800. This module thereby facilitates election of an RBridge to perform specific tasks. In some embodiment, such a task can be enabling ARP module 834 to respond to an ARP request for a virtual IP address.

ARP module 834 is responsible for ARP request replies, as described in conjunction with FIG. 3B. ARP module 834 of an elected RBridge also maintains mappings between a virtual MAC address and a virtual IP address and stores the mappings in Storage 840. Storage 840 can also include TRILL and IP routing information.

In some embodiments, gateway RBridge 800 may include a number of edge ports 802, as described in conjunction with FIG. 4. Edge ports 802 receive frames from (and transmit frames to) end devices. Ethernet frame processor 810 extracts and processes header information from the received frames. Ethernet frame processor 810 forwards the frames to IP management module 830 if there is no other intermediate RBridge between the end device and gateway RBridge 800.

Note that the above-mentioned modules can be implemented in hardware as well as in software. In one embodiment, these modules can be embodied in computer-executable instructions stored in a memory which is coupled to one or more processors in gateway RBridge 800. When executed, these instructions cause the processor(s) to perform the aforementioned functions.

In summary, embodiments of the present invention provide a method and system for providing redundancy among layer-3 gateways while facilitating load balancing across the gateways in a routed network. In one embodiment, a virtual IP router and an associated virtual RBridge are formed based on a number of gateway RBridges, wherein the virtual IP router acts as a default gateway to layer-3 and the virtual RBridge accommodates multiple paths toward the default gateway through a TRILL network. The virtual RBridge is used as the egress RBridge for egress frames from an end device. Such configuration provides a scalable and flexible solution to load balancing and across multiple switches.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A switching system, comprising:
a Transparent Interconnection of Lots of Links (TRILL) header processor unit configured to identify a virtual routing bridge (RBridge) identifier in a packet; and
an Internet Protocol (IP) header processor configured to identify a virtual IP address in the packet, wherein the virtual IP address is assigned to a virtual IP router associated with the virtual RBridge identifier.

2. The switching system of claim 1, wherein the virtual IP address is assigned to an interface of the virtual IP router.

3. The switching system of claim 1, wherein the virtual IP router is formed based on a plurality of physical RBridges with IP processing capabilities.

4. The switching system of claim 1, wherein the virtual RBridge is formed based on a plurality of physical RBridges.

5. The switching system of claim 1, further comprising an Ethernet header processor configured to identify a virtual Medium Access Control (MAC) address assigned to the virtual IP router.

6. The switching system of claim 5, further comprising an Address Resolution Protocol (ARP) module configured to respond to an ARP request for the virtual IP address with the virtual MAC address.

7. The switching system of claim 1, wherein the virtual IP router is a default gateway router.

8. The switching system of claim 1, further comprising a priority configuration mechanism which allows a priority to be set, thereby facilitating election of one of a plurality of physical RBridges that form the virtual IP router.

9. A system, comprising:
a virtual RBridge formed based on a number of RBridges functioning as a single logical RBridge;
a virtual MAC address associated with the virtual RBridge;
a virtual IP router formed based on the number of RBridges with IP processing capabilities functioning as a single logical IP router; and
a virtual IP address associated with the virtual IP router.

10. The system of claim 9, wherein the virtual IP address is associated with an interface of the virtual IP router.

11. The system of claim 9, wherein each RBridge in the number of RBridges comprises an IP protocol stack.

12. The system of claim 9, wherein packets destined to the virtual IP router are distributed among the number of RBridges, thereby facilitating load balancing and redundancy for the virtual IP router.

13. The system of claim 9, wherein the virtual MAC address is used as the source MAC address of outgoing Ethernet frames sent from the virtual IP router.

14. The system of claim 9, wherein one of the number of the RBridges is elected to respond to an ARP request for the virtual IP with the virtual MAC address.

15. The system of claim 9, wherein the virtual IP router is a default gateway router and the virtual IP address is the corresponding default IP address.

16. A method, comprising:
identifying a virtual RBridge identifier in a packet using TRILL header processing; and
identifying a virtual IP address in the packet using IP header processing, wherein the virtual IP address is assigned to a virtual IP router associated with the virtual RBridge identifier.

17. The method of claim 16, wherein the virtual IP address is assigned to an interface of the virtual IP router.

18. The method of claim 16, further comprising forming the virtual IP router based on a plurality of physical RBridges with IP processing capabilities.

19. The method of claim 16, further comprising forming the virtual RBridge based on a plurality of physical RBridges.

20. The method of claim 16, further comprising identifying a virtual MAC address assigned to the virtual IP router using Ethernet header processing.

21. The method of claim 20, further comprising responding to an ARP request for the virtual IP address with the virtual MAC address.

22. The method of claim 16, wherein the virtual IP router is a default gateway router.

23. The method of claim 16, further comprising setting a priority for facilitating election of one of a plurality of physical RBridges that form the virtual IP router.
